(19) United States
(12) Patent Application Publication
(10) Pub. No.: US 2016/0230080 A1
(43) Pub. Date: Aug. 11, 2016

(54) VISCOUS CARBON DIOXIDE COMPOSITION AND METHOD OF MAKING AND USING A VISCOUS CARBON DIOXIDE COMPOSITION

(71) Applicant: Esam Z. Hamad, Brighton, MI (US)

(72) Inventor: Esam Z. Hamad, Brighton, MI (US)

(21) Appl. No.: 14/615,121

(22) Filed: Feb. 5, 2015

(51) Int. Cl. C09K 8/594; E21B 43/16

(52) U.S. Cl. CPC C09K 8/594; E21B 43/164

(57) ABSTRACT

A carbon dioxide composition comprising carbon dioxide joined with at least one component comprising oligomers or small molecules to form a viscous carbon dioxide composition useable for improved efficiency in oil removal. The oligomers and small molecules chemically associate with carbon dioxide molecules to increase the viscosity over the carbon dioxide. The component or components may include at least two groups, with one comprising a proton donor group that binds to carbon dioxide, and the other comprising a proton acceptor group. The groups are molecularly arranged such that proton transfer results in associations that repeat to form a large structure to provide increased viscosity. A method of forming and using the viscous carbon dioxide composition involves injecting an additive of oligomers and/or small molecules into a stream of high pressure carbon dioxide adjacent a well head, and injecting the composition into the well.

### BACKGROUND OF THE INVENTION

The present invention is directed to a composition and method of forming and using viscous carbon dioxide (CO₂), and in particular for increasing the viscosity of dense carbon dioxide fluid, such as pressurized carbon dioxide for waterless hydraulic fracturing and carbon dioxide enhanced oil recovery.

Waterless hydraulic fracturing, such as of shale or rock that contains natural gas or oil, utilizes a fluid medium other than water to transport a proppant into the fractures that open under high pressure. Proppant are small solid particles, such as sand or ceramic particles, that prevent the fractures from closing after removing the applied pressure that caused rock fractures. Injecting gas into an oil field is also known for use as a technique for increasing the amount of oil that can be extracted from an oilfield, including the use of carbon dioxide in a process referred to as carbon dioxide enhanced oil recovery (CO₂ EOR). It is also known that increasing the viscosity of the injected gas is helpful in such a process, such as to improve the incremental recovery of the original oil in place in the reservoirs compared to neat carbon dioxide, and improve the gas utilization efficiency, such as in terms of the barrels of oil produced per unit weight or unit volume of gas injected, when using carbon dioxide enhanced oil recovery. However, research in carbon dioxide direct thickening has only resulted in one effective polymer, that being a fluorinated polymer, that is cost prohibitive due to the high cost of the many fluorine atoms in the polymer.

### SUMMARY OF THE INVENTION

The present invention provides a viscous carbon dioxide composition, as well as a method of making and using a viscous carbon dioxide composition.

According to an aspect of the present invention, a carbon dioxide composition comprises carbon dioxide mixed with at least one component selected from the group consisting of oligomers and small molecules capable of chemically associating with carbon dioxide molecules wherein said carbon dioxide composition has increased viscosity over said carbon dioxide. The additive component includes a first association group comprising a proton donor group that binds to carbon dioxide and a second association group comprising a proton acceptor group.

In a particular embodiment, a first component comprises a first association group and a second component comprises a second association group. In another embodiment, a single component comprises both the first and second association groups. Still further, the first association group may comprise X—H fragments, where X comprises an electronegative atom and H comprises a hydrogen atom. The first association group may comprise a hydroxyl group, a primary amine group, or a secondary amine group. The additive component may further include a carbon dioxide soluble group or groups, such as a carbon dioxide-philic group. The carbon dioxide composition may form a linear, branched or cyclic molecule, and in particular embodiments the reactants and products are both linear.

In still further embodiments, the carbon dioxide is in a supercritical state or a liquid state when mixed with the additive component, and the additive component may comprise a liquid at ambient conditions.

According to another aspect of the present invention, a method of forming a viscous carbon dioxide composition comprises providing an additive with at least one component selected from oligomers and small molecules capable of chemically associating with carbon dioxide molecules, providing carbon dioxide, and mixing the additive with the carbon dioxide. The carbon dioxide may be in a supercritical fluid state or a liquid state, and the additive may comprise a liquid at ambient conditions. In particular embodiments the additive comprises a first association group comprising a proton donor group that binds to carbon dioxide and includes a second association group comprising a proton acceptor group. The first and second association groups may be in separate components, or a single component may include both the first and second association groups. The additive may further include a carbon dioxide soluble group, including a carbon dioxide-philic group.

According to still another aspect of the invention, a method of using a viscous carbon dioxide composition comprises providing a container local to a well head that contains the additive and providing carbon dioxide, such as a stream of carbon dioxide in a pipe and delivering the additive into the stream of carbon dioxide to form a carbon dioxide composition, and injecting the carbon dioxide composition into a well.

The present invention further provides an efficient and cost effective viscous carbon dioxide composition by utilizing specific chemical association groups that comprise readily available atoms that are inexpensive, thereby providing less expensive chemical additives. The groups are preferably in small molecules or oligomers, and in particular embodiments the composition has a viscosity that is at least approximately twice that of neat/pure carbon dioxide at the same temperature and pressure. The present invention further provides a method of producing a viscous carbon dioxide composition proximate to a well site, such as by using small molecules or oligomers that are liquids at ambient conditions. The viscous carbon dioxide compositions of the present invention are also beneficial in waterless hydraulic fracturing as a result of the improved ability of the viscous fluid to carry a proppant from the surface through the well bore and then into the small fractures. These and other objects, advantages, purposes and features of this invention will become apparent upon review of the following specification in conjunction with the drawings.

### BRIEF DESCRIPTION OF THE DRAWINGS

FIG. 1 illustrates the injection or use of viscous carbon dioxide in an oil production field for the purpose of improving oil recovery from the reservoir;

FIG. 2A illustrates a viscous carbon dioxide composition comprising a mixture of two components with linear molecules wherein the reactants and products are linear;

FIG. 2B illustrates a viscous carbon dioxide composition comprising one component with a linear molecule wherein the reactants and products are linear;

FIG. 2C illustrates a viscous carbon dioxide composition comprising one component branched molecule; and

FIG. 3 discloses an apparatus and method for producing a viscous carbon dioxide composition proximate an injection well.

### DESCRIPTION OF THE PREFERRED EMBODIMENTS

The present invention will now be described with reference to the accompanying figures, wherein the numbered elements in the following written description correspond to like-numbered elements in the figures. The viscosity of carbon dioxide is enhanced in accordance with the present invention by the specific association described below, and preferably by the chemical association of small molecules and/or oligomers with carbon dioxide, where the small molecules or oligomers may be dissolved in pressurized carbon dioxide, for example. The viscosity enhanced carbon dioxide may then, for example and as discussed below, be used in waterless hydraulic fracturing and in enhanced oil recovery processes, by injecting the viscosity enhanced carbon dioxide composition, typically as a gas, into a reservoir. In one embodiment, the high viscosity carbon dioxide composition is prepared adjacent or near the well prior to injection.

The association methods or processes of the additive molecules takes place by way of chemical association of associating groups with one or more carbon dioxide molecules that in turn associate with another associating group. In this mechanism of forming such a composition, a carbon dioxide molecule is essential and chemically participates in the association.

The additive molecules comprising small molecules or oligomers are easier to dissolve, including in fluids, such as compared to polymers with high molecular weight. Moreover, after the small molecules and oligomers dissolve in the dense carbon dioxide they associate to form a network that enhances the viscosity. As discussed herein, small molecules are those having a molecular weight of approximately less than or equal to 2500 grams/mole, and oligomers are molecules with a degree of polymerization of approximately less than or equal to 100. Moreover, the oligomers may comprise end-capped oligomers wherein the associating groups are at one or both ends of the oligomers. Although large molecules and polymers may be employed, the use of small molecules or oligomers is advantageous due to the convenience that they may exist in a liquid form and provide fast solubility in pure/neat carbon dioxide.

Particular exemplary embodiments and formations of viscous carbon dioxide compositions in accordance with the present invention will now be discussed.

The chemical association process of associating groups with one or more carbon dioxide molecules that in turn associate with another associating group involves one or more components that are soluble in carbon dioxide and contain at least two groups: (i) a proton donor group that binds to carbon dioxide, and (ii) a proton acceptor group. In this embodiment the groups are arranged within the molecule or molecules in such a way that the proton transfer results in association that repeats itself to form a large structure, such as a chain, or three-dimensional structure, shape or configuration, causing the viscosity of the dense carbon dioxide to increase. The number of groups utilized may be equal to promote maximum utilization of the groups, that is an equal number of proton donor groups and proton acceptor groups.

The additive small molecules and/or oligomers may be in a liquid state or a gas state when mixed with the carbon dioxide. When the additive small molecules or oligomers are in a liquid state, the carbon dioxide may be in a liquid state or a supercritical state.

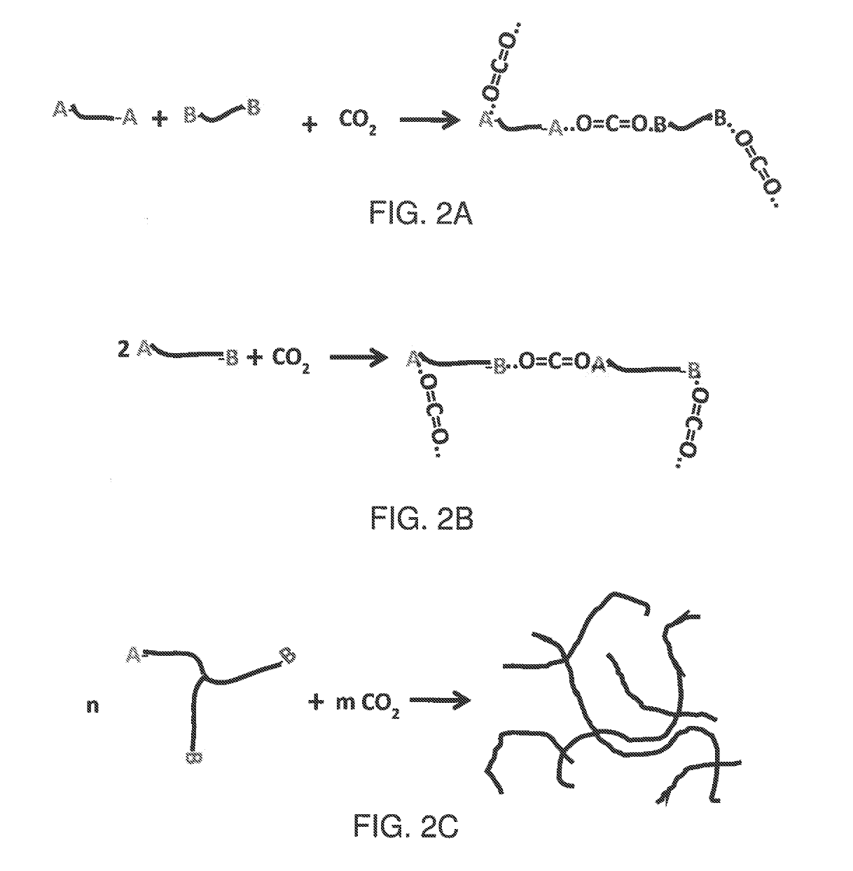

FIGS. 2A, 2B and 2C illustrate various exemplary viscous carbon dioxide compositions formed via the noted mechanism involving the chemical association of associating groups with one or more carbon dioxide molecules that in turn associate with another associating group. In particular, generic examples of the arrangement of the groups within the molecule(s) will be discussed where A and B represent association groups, and S is a carbon dioxide soluble group or moiety with affinity to carbon dioxide, or carbon dioxide-philic.

A first example is schematically shown in FIG. 2A, which illustrates a mixture of two components with linear molecules as follows:

A-SSS-A+B—SSSS—B+CO2→ . . . A-SSS-A.O═C═O.B—SSSS—B . . .

A second example is schematically shown in FIG. 2B, which illustrates one component with a linear molecule as follows:

2A-SSSSS—B+CO2→ . . . A-SSSSS—B.O═C═O.A-SSSSS—B . . .

A third example is schematically shown in FIG. 2C, which illustrates a one component branched molecule as follows:

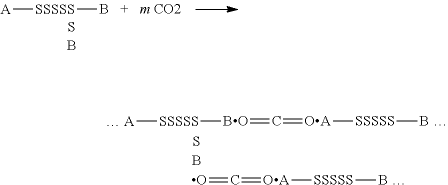

In the above noted embodiments, the group A association group represents the proton donor that binds to carbon dioxide and has X—H fragments, where X is an electronegative atom such as oxygen, nitrogen or fluorine, and the like, and H comprises a hydrogen atom having an electropositive charge. The group is acidic acting as compared to group B. Examples of proton donor groups include (i) hydroxyl groups, which form carbonate ions when they lose a proton and bind with carbon dioxide, and (ii) primary and secondary amine groups, which form carbamate or bicarbonate when they lose a proton and bind with carbon dioxide. Examples of hydroxyl groups include (a) R—O—H (hydroxyl group connected to a carbon atom: i.e. alcohol), and (b) (CH3)2 Si—O—H, (hydroxyl group connected to a silicon atom).

The group B association group represents the proton acceptor group that is capable of attracting and dissociating a proton from other groups to form a cationic group. It includes those basic acting groups such as quaternizable derivatives of ammonia: primary, secondary and tertiary amines, amidine, guanidine, dicyandiamides and nitrogen containing heterocyclic compounds. It also includes carboxylates and organic basis. Examples of associating group B include: amines or related groups, include: primary, secondary or tertiary Amines, guanidine, Amidine, NH2-C(R)═NH, DBU 1,8-Diazabicycloundec-7-ene, Pyridinium, Imidazolium. It should be understood that amines and related groups could function as both group A and B, that is as a proton donor and acceptor.

It is desired for the additive molecules to remain carbon dioxide soluble even after the association because if they precipitate their thickening function will be inhibited. The presence of carbon dioxide-philic groups in the molecule may be used to keep them in solution. Examples of carbon dioxide-philic soluble groups include, but are not limited to: vinyl acetate, ethylene —CH2-, propylene oxide CH(CH3)-O—, dimethyl siloxane: Si(CH3)2-O—, acetylenic alcohols: HO—CH2-C═C—H, fluorinated hydrocarbon groups, and branched and hyper-branched hydrocarbon groups.

In the above noted mechanisms for forming a viscous carbon dioxide composition, the molecules could be linear, branched or cyclic, they could contain one, two or multiple association groups. These groups could be located anywhere on the molecules, as long as the inter-molecular association will lead to a large multi-molecule structure. A preferred group arrangement is when the association groups are at the ends of a linear molecule or the end of the branches of a branched molecule. This will promote the formation of the largest or greatest structure/network for the same amount of the added chemicals. Minimizing the amount of chemicals needed for a given increase in viscosity advantageously minimizes the cost and maximizes the profit from the incremental oil produced, or from the hydraulic fracturing operation.

As noted above, viscous carbon dioxide compositions in accordance with the present invention may advantageously be used in both waterless hydraulic fracturing and enhanced oil recovery operations. Regarding waterless hydraulic fracturing, the compositions may be used, for example, by those targeting hydraulic fracturing in water-sensitive formations, hydraulic fracturing in areas where water is scarce, or those seeking more environmentally friendly hydraulic fracturing practices. In the hydraulic fracturing operation, a fluid is injected into the well with additives for multiple functions including: carrying the proppant downhole to the fracture region and inside the small fractures, propagating the high pressure generated on the surface all the way to the regions where rock fractured are sought, carrying corrosion inhibiting chemicals to minimize corrosion of the oil well tubing, and controlling fluid viscosity and rheology.

The optimum dispersion of proppant in the fluid takes place when the two have the same density. However, this is difficult and expensive to achieve. In addition when using carbon dioxide as a fluid, its density will change with changes in temperature and pressure as well depth changes. It is therefore desirable to increase the viscosity of the carbon dioxide so as to minimize the mobility of the proppant relative to the carbon dioxide. The proppant now flows in substantially the same speed and direction as the carbon dioxide. This provides control by the operators allowing them to guide the proppant (suspended in carbon dioxide) to the proper or desired locations.

Regarding enhanced oil recovery, viscous carbon dioxide compositions in accordance with the present invention may be used in carbon dioxide flooding to enhance the recovery of the remaining oil in place after the primary and secondary oil recoveries. The increased viscosity of the injected carbon dioxide improves the incremental recovery and gas utilization efficiency. The increased viscosity will reduce the mobility of the gas in the reservoir, and this in turn will provide better sweep efficiency by: 1) reducing fingering, 2) providing gravity override, which is particularly beneficial for thick layers of oil rich zones, and 3) stabilizing the displacement front.

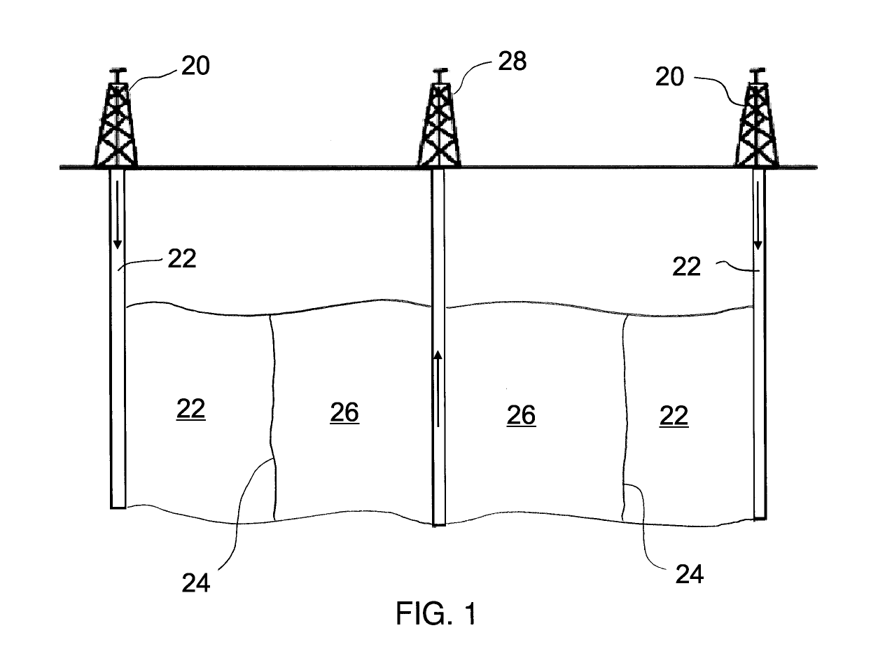

With reference to FIG. 1, a viscous carbon dioxide composition is injected into the ground via one or more injection wells 20. The thicker viscous carbon dioxide compositions 22 promote the desirable formation of a more uniform displacement front 24 to maximize the sweep efficiency through or in the oil rich zones 26, and thereby promote withdrawing of the oil via production well 28. As understood relative to FIG. 1, a viscous carbon dioxide composition is less mobile and thus will not incur as much gravity drainage, which takes place in thick layers of oil rich zones. In the case of less viscous carbon dioxide, the lower density of the injected carbon dioxide compared to the oil will, over time, result in the carbon dioxide floating to the top of the formation. This is referred to as “gravity drainage”, while “fingering” is the fast advance of the injected carbon dioxide in higher permeability regions, and slower advance in other lower permeability regions.

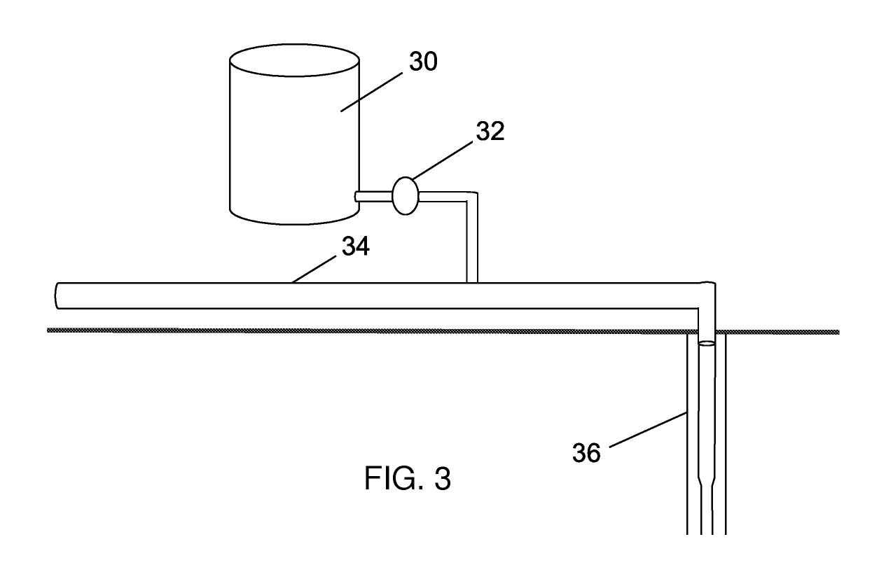

The present invention further provides an efficient method of producing high viscosity carbon dioxide proximate to the well site by utilizing specific chemical association preferably in small molecules or oligomers to prepare the gas-additive mixture. Small molecules or oligomers are usually liquids at ambient conditions and the equipment for dissolving such liquids are smaller and less expensive. For example with reference to FIG. 3, such equipment may comprise a tank 30 for holding the additive, a high pressure pump 32 connected with the tank 30 for delivering the additive into a supply pipe 34, where the supply pipe 34 carries high pressure carbon dioxide. The mixture of the additive and carbon dioxide that forms the high viscosity carbon dioxide is then delivered into the well head 36 of the injection well. In contrast, polymers are typically solids and the equipment needed to dissolve solids might require high-pressure mixing tanks due to the slow kinetics of large molecule solubilization.

The present invention thus provides high viscosity carbon dioxide compositions, wherein the viscosity of the mixture is increased by approximately at least twice that of neat/pure carbon dioxide at the same temperature and pressure. In a particular embodiment the viscous carbon dioxide composition is formed by using small molecules that comprise readily available atoms and groups that are inexpensive, thereby providing less expensive chemical additives. A further feature of the use of small molecules is the absence of molecular weight degradation at high shear rates. Moreover, the noted associations are reversible. If, for example, associations break down due to high shear rate, such as inside the pump 32 for example, then the association will re-form once the shear rate returns to lower values encountered in the reservoir. As noted, the viscous carbon dioxide composition is useful when injected into a reservoir to promote the extraction of oil. The composition may be injected as a gas, but depending on the temperature and pressure of the reservoir may alternatively be injected as a liquid.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A carbon dioxide composition, said carbon dioxide composition comprising:
carbon dioxide mixed with at least one component selected from oligomers and small molecules capable of chemically associating with carbon dioxide molecules wherein said carbon dioxide composition has increased viscosity over said carbon dioxide.

2. The carbon dioxide composition of claim 1, wherein said component comprises a first association group comprising a proton donor group that binds to carbon dioxide and includes a second association group comprising a proton acceptor group.

3. The carbon dioxide composition of claim 2, wherein a first component comprises said first association group and a second component comprises said second association group.

4. The carbon dioxide composition of claim 3, wherein said first component and said second component each further comprise a carbon dioxide soluble group.

5. The carbon dioxide composition of claim 2, wherein a single component comprises both said first association group and said second association group.

6. The carbon dioxide composition of claim 2, wherein said first association group comprises X—H fragments, where X comprises an electronegative atom and H comprises a hydrogen atom.

7. The carbon dioxide composition of claim 6, wherein said first association group comprises a hydroxyl group, a primary amine group, or a secondary amine group.

8. The carbon dioxide composition of claim 2, wherein said component comprises a branched molecule.

9. The carbon dioxide composition of claim 1, wherein said component further comprises a carbon dioxide soluble group.

10. The carbon dioxide composition of claim 1, wherein said component further comprises a carbon dioxide-philic group.

11. The carbon dioxide composition of claim 1, wherein said component is linear, branched or cyclic.

12. The carbon dioxide composition of claim 1, wherein said carbon dioxide is a supercritical fluid or a liquid when mixed with said component.

13. The carbon dioxide composition of claim 12, wherein said component comprises a liquid at ambient conditions.

14. The carbon dioxide composition of claim 1, wherein said composition has a viscosity that is at least approximately twice that of neat/pure carbon dioxide at the same temperature and pressure.

15. A carbon dioxide composition, said composition comprising:
carbon dioxide mixed with at least one component selected from oligomers and small molecules capable of chemically associating with carbon dioxide molecules wherein said carbon dioxide composition has increased viscosity over said carbon dioxide, wherein said component comprises a first association group comprising a proton donor group that binds to carbon dioxide and includes a second association group comprising a proton acceptor group, and wherein said component further comprises a carbon dioxide soluble group.

16. The carbon dioxide composition of claim 15, wherein said carbon dioxide soluble group comprises a carbon dioxide-philic group.

17. The carbon dioxide composition of claim 15, wherein a first component comprises said first association group and a second component comprises said second association group.

18. The carbon dioxide composition of claim 15, wherein a single component comprises both said first association group and said second association group.

19. The carbon dioxide composition of claim 15, wherein said carbon dioxide is a supercritical fluid or a liquid when mixed with said component, and wherein said component comprises a liquid at ambient conditions.

20. A method of forming and using an enhanced viscosity carbon dioxide composition, said method comprising:
providing a container local to a well head, said container containing an additive with at least one component selected from the group consisting of oligomers and small molecules capable of chemically associating with carbon dioxide molecules;
providing carbon dioxide;
delivering the additive into the carbon dioxide to form a carbon dioxide composition; and
injecting the carbon dioxide composition into a well.

21. The method of claim 20, wherein said carbon dioxide comprises carbon dioxide in a supercritical fluid state or a liquid state.

22. The method of claim 21, wherein said additive comprises a liquid at ambient conditions.

23. The method of claim 20, wherein said additive comprises a first association group comprising a proton donor group that binds to carbon dioxide and includes a second association group comprising a proton acceptor group.

24. The method of claim 23, wherein a first component comprises said first association group and a second component comprises said second association group.

25. The method of claim 23, wherein a single component comprises both said first association group and said second association group.

26. The method of claim 20, wherein said additive further comprises a carbon dioxide soluble group.

27. The method of claim 20, further including a pump operatively connected to the container, and wherein said delivering the additive into the carbon dioxide comprises pumping the additive into the carbon dioxide with the pump.
